(19) United States
(12) Patent Application Publication
(10) Pub. No.: US 2012/0013098 A1
(43) Pub. Date: Jan. 19, 2012

(54) WHEELCHAIR MODULAR REAR SUSPENSION

(75) Inventor: Harlan H. Hart, Madera, CA (US)

(73) Assignee: SUNRISE MEDICAL HHG, INC., Longmont, CO (US)

(21) Appl. No.: 12/838,869

(22) Filed: Jul. 19, 2010

(51) Int. Cl. A61G 5/00; B60G 9/00

(52) U.S. Cl. 280/250.1; 280/124.1

(57) ABSTRACT

A modular rear suspension system resiliently supports a wheelchair. The system includes a suspension mount having an upper shackle and a link arm mount. The link arm mount of the suspension mount has an upper pivot and a lower pivot. An axle tube is configured to rotatably support a pair of rear wheels, and an axle tube clamp engages an end of the axle tube. The axle tube clamp has a pivot and a lower shackle. The axle tube includes a link arm tube mount having a pivot. An upper link arm is supported for pivoting movement between the link arm mount upper pivot and the link arm tube mount pivot. A lower link arm is supported for pivoting movement between the link arm mount lower pivot and the axle tube clamp pivot. A resilient member is pivotally connected between the upper and lower shackles.

### BACKGROUND OF THE INVENTION

This invention relates in general to wheelchair frames. In particular, this invention relates to suspension systems carried by wheelchair frames.

Wheelchairs are a class of personal mobility vehicle that provide greater ambulatory freedom to persons having limited movement abilities. A frame supports a seating assembly having a seat bottom and a backrest. The frame also supports a plurality of wheels that may be power driven or manually operated. To improve ride comfort, some wheelchairs are provided with suspended wheels to isolate the user from bumps and other jarring loads encountered during use. In many manually operated wheelchairs, these suspension systems add considerable weight to the frame assembly and thus increase the effort to operate and transport these chairs.

It would be desirable to provide a wheelchair suspension system that is lightweight. It would further be desirable to provide a wheelchair suspension system that is easily adaptable to a wheelchair having a rigidly mounted axle arrangement.

### SUMMARY OF THE INVENTION

This invention relates to a wheelchair suspension system that includes a base frame of a wheelchair and an axle tube connecting a pair of spaced-apart wheels. A four bar linkage is configured to permit translation and rotation of the axle tube relative to the base frame. The wheelchair suspension system is configured as a rear wheel suspension system for a wheelchair. The rear wheel suspension system includes a suspension mount, an axle tube, a pair of suspension links, and a resilient member. The suspension mount is adapted to support the rear suspension system relative to a wheelchair frame. The axle tube is adapted to support a pair of rear wheels. The pair of suspension links pivotally support each end of the axle tube for vertical movement. The resilient member supports the axle tube and is mounted at one end for pivotal movement along a first axis and mounted at an opposite end for pivotal movement along a second axis. The second axis is in a different orientation relative to the first axis.

The invention further relates to a modular rear suspension system configured to resiliently support a wheelchair. The system includes a suspension mount having an upper shackle and a link arm mount. The link arm mount of the suspension mount has an upper pivot and a lower pivot. An axle tube is configured to rotatably support a pair of rear wheels, and an axle tube clamp engages an end of the axle tube. The axle tube clamp has a pivot and a lower shackle. The axle tube includes a link arm tube mount having a pivot. An upper link arm is supported for pivoting movement between the link arm mount upper pivot and the link arm tube mount pivot. A lower link arm is supported for pivoting movement between the link arm mount lower pivot and the axle tube clamp pivot. A resilient member is pivotally connected between the upper and lower shackles.

A wheelchair comprises a base frame, an axle tube and a pair of suspension link arms. The axle tube is configured to support a pair of wheels for rotation. The suspension mount includes a pair of pivot points, and the suspension mount is configured to transfer user weight between the base frame and the axle tub. The pair of suspension link arms connect the suspension mount pivot points to the axle tube. The suspension link arms are configured to transfer forward movement of the axle tube to forward movement of the wheelchair and to permit the axle tube to translate and rotate relative to the base frame.

A wheelchair comprises a base frame and a wheel lock engaged to a portion of the base frame. The wheel lock is configured for selective engagement with at least one of a pair of wheels. An axle tube is configured to support the pair of wheels for rotation. A suspension mount is configured to support the axle tube for relative movement with the base frame through a range of suspension articulation. The suspension mount is connected to a first end of a resilient member and the base frame is connected to a second end of the resilient member. The at least one of the pair of wheels is configured to be selectively engaged by the wheel lock throughout the range of suspension articulation.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is a perspective view of a prior art wheelchair frame assembly having a rigidly mounted axle assembly;

FIG. 2A is a side elevational view of an embodiment of a wheelchair frame having a resiliently mounted axle and suspension assembly;

FIG. 2B is a rear elevational view of the wheelchair frame assembly of FIG. 2A;

FIG. 3 is a perspective view of another embodiment of a wheelchair axle and suspension assembly;

FIG. 4 is an exploded view of the axle and suspension assembly of FIG. 3;

FIG. 5 is an enlarged elevational view of a portion of the axle and suspension assembly of FIGS. 2A and 2B;

FIG. 6 is an enlarged elevational view of a portion of the axle and suspension assembly of FIGS. 3 and 4;

FIG. 7 is a perspective view, in partial cross section, of the portion of the axle and suspension assembly of FIG. 6;

FIG. 8A is a rear elevational view of an embodiment of a wheelchair frame assembly having a resiliently mounted axle and suspension assembly in a neutral position;

FIG. 8B is a rear elevational view of the wheelchair frame assembly of FIG. 8A showing the resiliently mounted axle and suspension assembly in a deflected position;

FIG. 9 is an elevational view of an embodiment of a wheelchair frame assembly having a resiliently mounted axle and suspension assembly disposed in a jounce condition and a rebound condition; and

FIG. 10 is an enlarged view of the wheel chair frame assembly of FIG. 9 showing the relationship of the suspension deflection to a wheel lock assembly.

### DETAILED DESCRIPTION OF THE PREFERRED EMBODIMENT

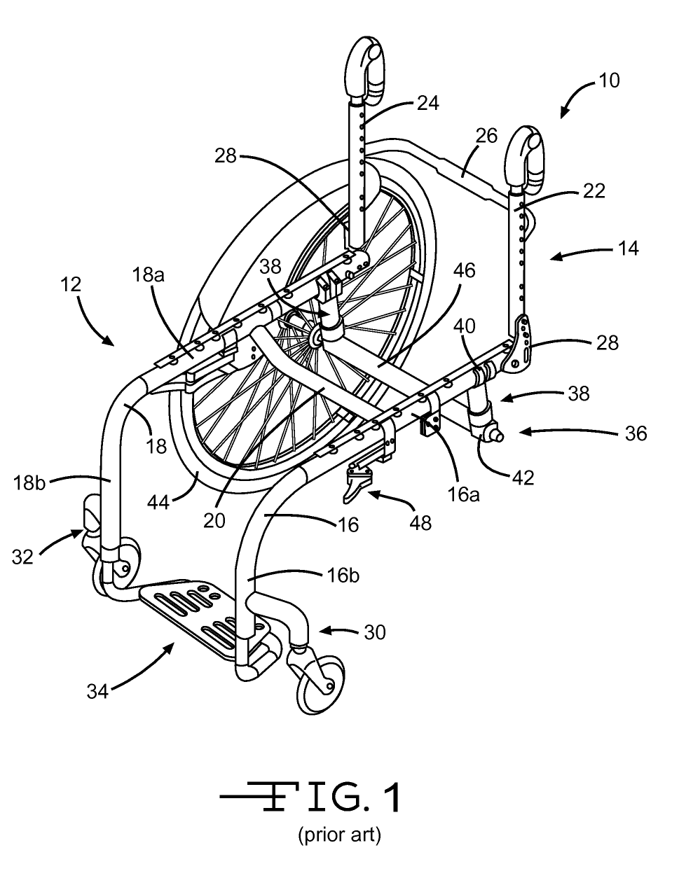

Referring now to the drawings, there is illustrated in FIG. 1 a prior art wheelchair frame assembly, shown generally at 10. The wheelchair frame assembly 10 includes a base frame assembly 12 and a backrest frame assembly 14. The base frame assembly 12 includes a pair of spaced apart side frames 16 and 18 connected together by a cross member 20. The side frames 16 and 18 include first legs 16a, 18a and second legs 16b, 18b, respectively. The backrest frame assembly 14 includes a pair of spaced apart upright frame members, shown as backrest canes 22 and 24. The backrest canes 22 and 24 are connected together by a backrest cross member 26. The backrest frame assembly 14 is pivotally connected to the base frame 12 by hinges 28. The second legs 16b and 18b of the base frame 12 include pivotally mounted caster assemblies 30 and 32. The ends of the second legs 16b and 18b are connected together by a footrest assembly, shown generally at 34.

A rigid axle assembly, shown generally at 36, is secured to the base frame 12. The rigid axle assembly 36 includes a pair of spaced apart axle mounts 38 that connect the axle assembly 36 to the base frame 12. The axle tube 46 is rigidly fixed to the base frame 12 by the axle mounts 38. The axle mounts 38 include a frame clamp end 40 and an axle tube clamp end 42. The frame clamp ends 40 engage selected portions the first legs 16a and 18a such that rear wheels, shown as one rear wheel 44, may be moved closer to or farther away from the caster assemblies 30 and 32. The axle tube clamp ends 42 engage portions of an axle tube 46. The axle tube 46 is configured to support the rear wheels 44 for rotation. A wheel brake assembly 48 is mounted to the frame and configured to be moved into contact with at least one of the rear wheels 44 to selectively prevent rotation of the wheel 44 relative to the base frame 46.

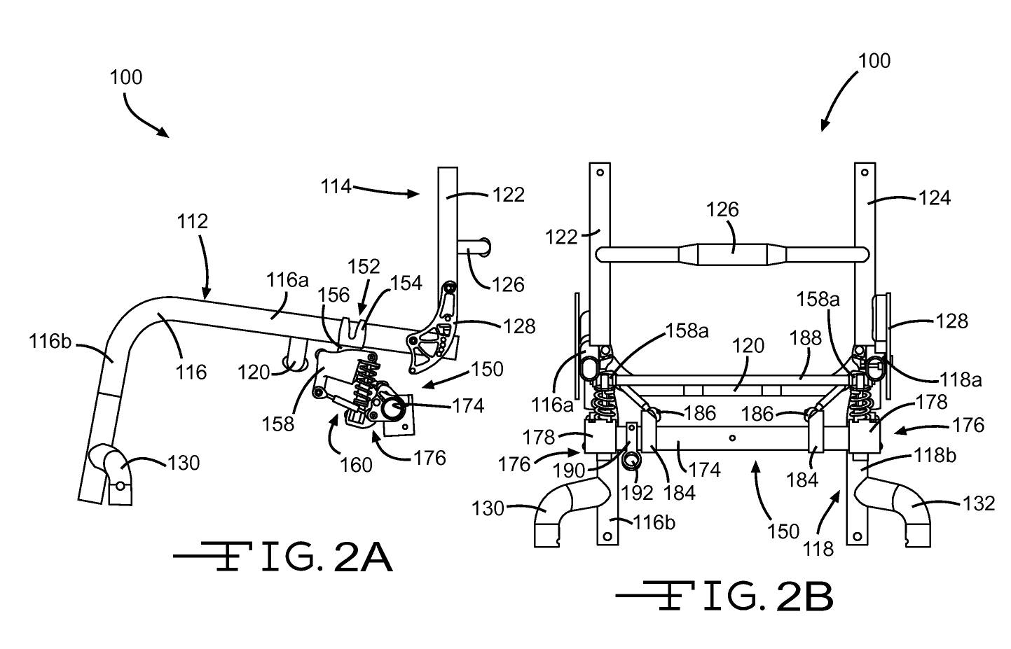

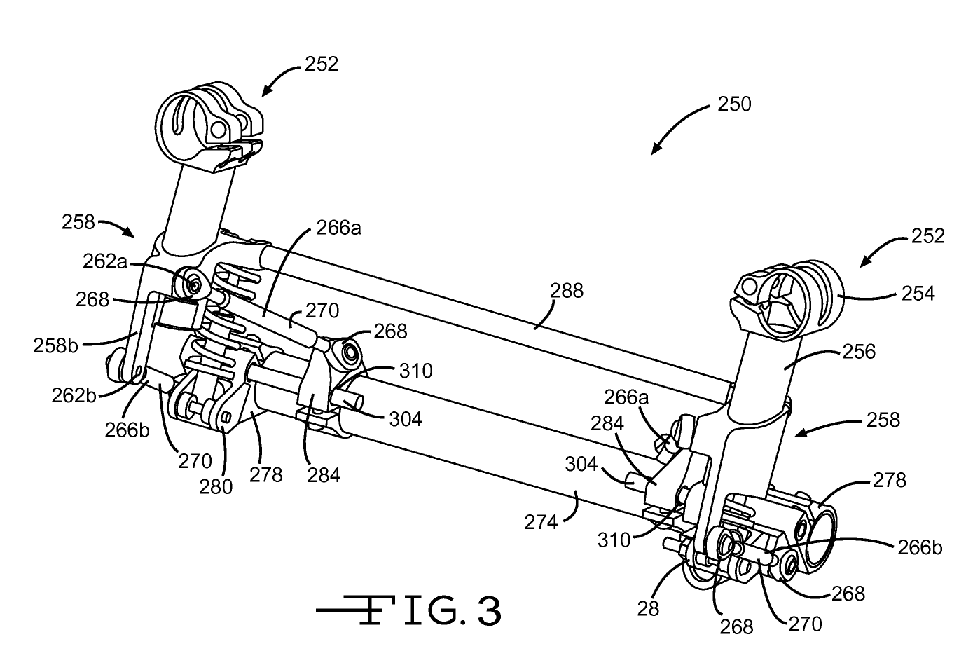

Referring now to FIGS. 2A and 2B, there is illustrated an embodiment of a wheelchair frame assembly, shown generally at 100, that includes a resiliently mounted axle assembly, shown generally at 150. The wheelchair frame assembly 100 includes a base frame assembly 112 and a back rest assembly 114. Though illustrated as an open base frame assembly, similar to the prior art base frame assembly 10, such an open construction is not required. The base frame assembly 112 includes a pair of spaced apart side frames 116 and 118 connected together by a cross member 120. The side frames 116 and 118 include first legs 116a, 118a and second legs 116b, 118b, respectively.

The backrest frame assembly 114 includes a pair of spaced apart upright frame members, shown as backrest canes 122 and 124. The backrest canes 122 and 124 are connected together by a backrest cross member 126. The backrest frame assembly 114 is pivotally connected to the base frame 112 by hinges 128. The second legs 116b and 118b of the base frame 112 include caster tubes 130 and 132 that pivotally support caster assemblies (not shown). The ends of the second legs 116b and 118b may be connected together by a footrest assembly (not shown).

The resiliently mounted axle assembly 150 includes a pair of spaced apart frame hangers 152. The frame hangers 152 have a frame clamp end 154 and a sleeve end 156 that extends from the clamp end 154. The sleeve end 156 is connected to a suspension mount 158 that supports one part of a resilient suspension system 160. The sleeve end 156, shown as an oval cylindrical extension in various embodiments, may be any shape that permits height adjustment of the suspension mount 158 relative to the base frame 112. Shims (not shown) may be positioned between the sleeve end 156 and the suspension mount 158 to provide incremental height adjustment between the base frame 112 and the axle tube 174.

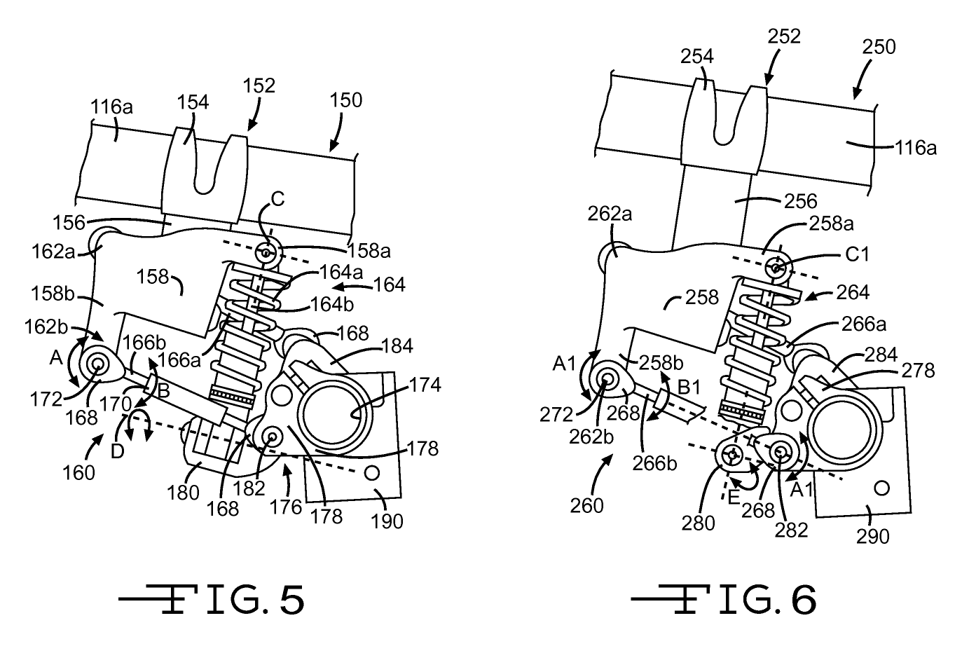

Referring now to FIG. 5, the suspension mount 158 includes an upper mounting shackle 158a, that pivotally supports a resilient suspension member 164, shown as a coil spring and shock absorber assembly, and a link arm mount 158b. Though shown as a coaxially mounted coil spring 164a over a shock absorber 164b, the resilient suspension member 164 may have any type of resilient member and may or may not include the shock absorbing damper 164b. The upper shackle 158a permits the upper end of the resilient suspension member 164 to pivot about an axis “C”.

The link arm mount 158b has an upper pivot 162a and a lower pivot 162b. The upper pivot 162a supports an upper link arm 166a for relative pivoting movement. The lower pivot 162b supports a lower link arm 166b for relative pivoting movement. The link arms 166a and 166b are illustrated as having swivel ends 168 and an adjustable link section 170. The swivel ends 168 permit rotational movement about a pivot axis 172 and rotational movement about the link section 170, as shown by arrows A and B. These two degrees of freedom of movement permit suspension reactions that are more isolated from the user. The improved isolation permits a controlled degree of lateral movement of the suspension system relative to the base frame 112. The lateral degree of freedom of the suspension allows one wheel to react without transmitting a similar reaction to the other wheel, even though both wheels are rigidly connected together.

The adjustable link section 170 may be threaded members, similar to a turnbuckle, that are length adjustable. Alternatively, the link section 170 may be of a fixed length. One of the upper and lower link arms 166a and 166b may be fixed or adjustable or, alternatively, neither or both may be adjustable. When one or both of the link sections 170 are adjustable, the camber setting of the rear wheels may be reconfigured relative to the base frame 112. This adjustment permits the resilient suspension members to be oriented relative to the loads generated by wheel excursions. In other words, the resilient suspension member 164 can be oriented to be coaxially aligned with the transmitted forces or oriented at a relative angle to the axial forces. Thus, the suspension reaction characteristics can be adjusted without replacing suspension components. The upper and lower link arms 166a and 166b work together in a 4-bar or 4-link arrangement as the rear wheels move in reaction to road discontinuities. In one embodiment, these link arms may move in a parallelogram configuration. The link arms 166a and 166b are generally rigid along their longitudinal axes.

The resiliently mounted axle assembly 150 includes an axle tube 174 that engages a pair of spaced-apart axle tube mounts 176. Each of the axle tube mounts 176 has an axle tube clamp end 178 and a lower suspension shackle 180. In the illustrated embodiment of FIG. 5, the clamp end 178 is adapted to frictionally engage the outer surface of the axle tube 174. Alternatively, the clamp end 178 may be bolted or otherwise fixed to the axle tube 174. The axle tube mount 176 also includes a lower pivot 182 that is pivotally connected to the other swivel end 168 of the lower link arm 166b. The tube clamp lower pivot 182 provides a similar degree of freedom of movement for the swivel end 168 as the lower pivot 162b. The resilient suspension member 164 supports the axle tube 174 relative to the base frame 112. The resilient suspension member 164 is mounted at one end for pivotal movement along a first axis and mounted at an opposite end for pivotal movement along a second axis that is in a different orientation relative to the first axis.

The lower suspension shackle 180 permits the lower end of the resilient suspension member 164 to pivot about an axis “D” that is shown generally perpendicular to the upper pivot axis C. Thus, in the illustrated embodiment, the resilient suspension member 164 has mounting axes that are perpendicularly oriented. This orientation of upper and lower pivot axes (i.e., axes C and D) permits the upper and lower link arms 166a and 166b to maintain the limited lateral degree of freedom as the suspension articulates through its jounce and rebound range of motion.

In the illustrated embodiment of FIGS. 2A and 2B, there are shown spaced-apart upper link arm tube mounts 184. Though shown as separate mounting structures, in an alternative embodiment, these upper arm tube mounts 184 may be integrally formed with the tube mounts 176. The upper arm tube mounts 184 include pivots 186 that define pivot axes that are oriented at a canted angle, such as a 45 degree angle shown in FIG. 2B, relative to the axle tube 174. The pivots 186, defined by the pivot axes, may be oriented at any relative angle to the axle tube 174, from parallel to perpendicular. The pivots 186 of the upper arm tube mounts also provide the same degree of freedom of movement for the swivel end 168 as the upper pivot 162a.

The upper shackles 158a, on each side of the wheelchair frame 112, may be interconnected by a suspension sway bar 188. The sway bar 188 connects the upper suspension points to each other and provides an added degree of rigidity to the base frame 112. The axle tube 174 connects the right and left rear wheels together as a solid axle arrangement. Thus, the axle tube 174 provides a rigid and light weight structure to support the rear wheels and provide suspension mounting points inboard of the rear wheels. An anti-tip mounting block 190 may be mounted to the axle tube 174. The anti-tip mounting block 190 may include a bore 192 that is generally perpendicular to the longitudinal axis of the axle tube 174 and supports an anti-tip wheel assembly (not shown). Alternatively, the anti-tip mounting block 190 may be used to rotate and adjust the axle tube and orientation of the plane of the rear wheel camber and toe-in/toe-out adjustment relative to the base frame 112. In other words, the point of the wheels that is closest to a plane defined by the base frame 112 may be rotated towards the front or rear of the wheelchair, effecting a toe adjustment with the camber adjustment.

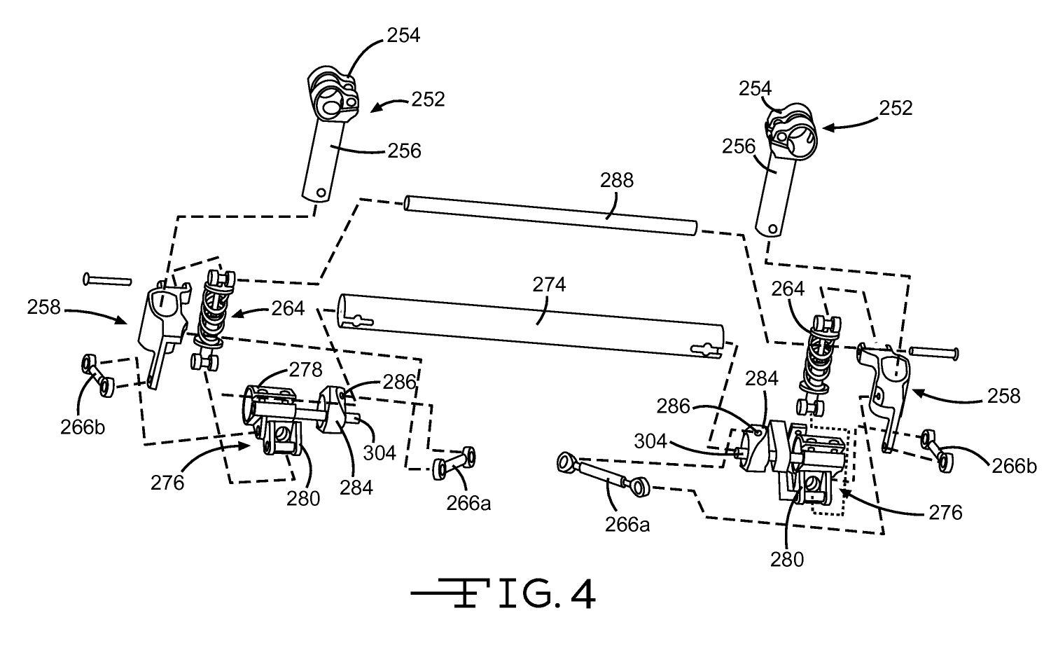

Referring now to FIGS. 3, 4, 6, and 7 there is illustrated another embodiment of a resiliently mounted axle assembly, shown generally at 250. The resiliently mounted axle assembly 250 is similar to the previously described axle assembly embodiment 150. Like numbers will be used to describe like features between the two embodiments. The resiliently mounted axle assembly 250 includes a pair of spaced apart frame hangers 252. The frame hangers 252 have a frame clamp end 254 and a sleeve end 256 that extends from the clamp end 254. The sleeve end 256 is connected to a suspension mount 258 that supports one part of a resilient suspension system 260. The sleeve end 256, shown as an oval cylindrical extension in various embodiments, may be any shape that permits height adjustment of the suspension mount 258 relative to the base frame 112.

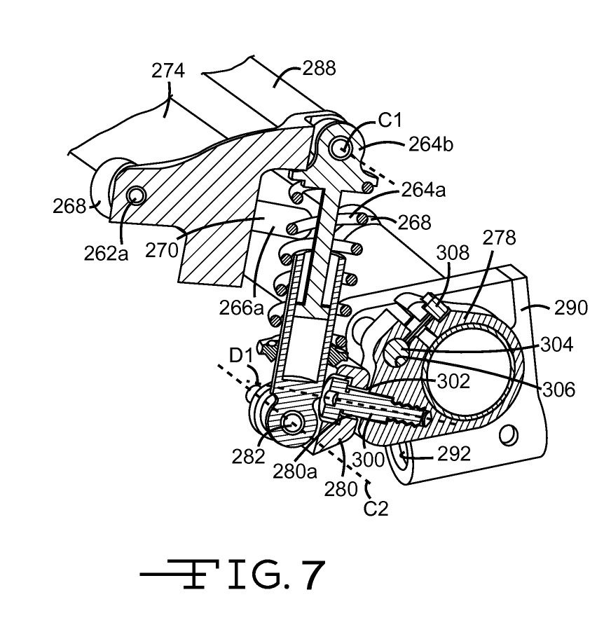

Referring now to FIG. 6, the suspension mount 258 includes an upper spring shackle 258a, that pivotally supports a resilient suspension member 264, shown as a coil spring and shock absorber assembly, and a link aim mount 258b. Though shown as a coaxially mounted coil spring 264a over a shock absorber 264b, the resilient suspension member 264 may have any type of resilient member and may or may not include the shock absorbing damper 264b. The upper shackle 258a permits the upper end of the resilient suspension member 264 to pivot about an axis “C1”, as shown in FIG. 7.

The link arm mount 258b has an upper pivot 262a and a lower pivot 262b. The upper pivot 262a supports an upper link arm 266a for relative pivoting movement. The lower pivot 262b supports a lower link arm 266b for relative pivoting movement. The link arms 266a and 266b are illustrated as having swivel ends 268 and an adjustable link section 270. The swivel ends 268 permit rotational movement about a pivot axis 272 and rotational movement about the link section 270, as shown by arrows A1 and B1. These two degrees of freedom of movement permit suspension reactions that are substantially isolated from the user. The improved isolation permits a controlled and limited degree of lateral movement of the axle relative to the base frame 112. The lateral degree of freedom of the suspension allows one wheel to react without transmitting a similar reaction to the other wheel, even though both wheels are rigidly connected together.

The adjustable link section 270 may be threaded members that are length adjustable. Alternatively, the link section 270 may be of a fixed length. One of the upper and lower link arms 266a and 266b may be fixed or adjustable or, alternatively, neither or both may be adjustable. When one or both of the link sections 270 are adjustable, the camber setting of the rear wheels may be reconfigured relative to the base frame 112. This adjustment permits the resilient suspension members to be oriented relative to the loads generated by wheel excursions. In other words, the resilient suspension member 264 can be oriented to be coaxially aligned with the transmitted forces or oriented at a relative angle to the axial forces. Thus, the suspension reaction characteristics can be adjusted without replacing suspension components. The upper and lower link arms 266a and 266b work together in a 4-bar or 4-link arrangement as the rear wheels move in reaction to road discontinuities. In one embodiment, these link arms may move in a parallelogram configuration. The link arms 266a and 266b are generally rigid along their longitudinal axes.

The resiliently mounted axle assembly 250 includes an axle tube 274 that engages a pair of spaced-apart axle tube mounts 276. Each of the axle tube mounts 276 has an axle tube clamp end 278 and a lower suspension shackle 280. In the illustrated embodiment of FIG. 6, the clamp end 278 is adapted to frictionally engage the outer surface of the axle tube 274. Alternatively, the clamp end 278 may be bolted or otherwise fixed to the axle tube 274. The tube mount 276 also includes a lower pivot 282 that is pivotally connected to the other swivel end 268 of the lower link arm 266b. The tube clamp lower pivot 282 provides a similar degree of freedom of movement for the swivel end 268 as the lower pivot 262b. The lower suspension shackle 280 is configured to pivot relative to the axle tube clamp end 278, as shown by arrows “E”.

Referring now to FIG. 7, the lower suspension shackle 280 is pivotally connected to the axle tube clamp 278 by a pivot axle 300. The pivot axle 300 permits the lower suspension shackle 280 to pivot about an axis “D1” that is generally perpendicular to the upper pivot axis C1. In the illustrated embodiment, the pivot axle 300 is a shoulder bolt that extends through an optional bushing 302. The bushing 302 may fit into a mounting bore 280a formed through part of the lower shackle 280. The bushing 302 may be a top-hat shape such that it takes up rotational and thrust loads between the lower shackle 280 and the tube clamp 278. Alternatively, the optional bushing 302 may be a sleeve bushing, a disk-shaped thrust bushing, or a rolling bearing element. The pivot axle 300 may be any structure that permits movement of the lower shackle 280 relative to the axle tube clamp 278.

The lower end of the resilient suspension member 264 is mounted in the lower shackle 280 and pivots about an axis “C2” relative to the lower shackle 280. The axes C1 and C2 are illustrated as generally parallel to each other. Therefore, the lower shackle 280 includes third axis C2 that is generally parallel to first axis C1. The resilient suspension member 264 is mounted along the first axis of the upper shackle and third axis of the lower shackle 280. The lower shackle 280 is configured to pivot about the second axis D1 relative to the axle tube clamp 278. Thus, in the illustrated embodiment, the lower end of the resilient suspension member 264 has two degrees of freedom of movement that are generally perpendicularly oriented. The orientations of upper pivot axis C1 and the lower pivot axes C2 and D1 permit the upper and lower link arms 266a and 266b to maintain their limited lateral degrees of freedom as the suspension articulates through its jounce and rebound range of motion. Additionally, the two lower pivot axes C2 and D1 help to reduce stresses on suspension components such as the axle tube clamp 278, the resilient suspension member 264 and the link arm 266b as the axle tube 274 moves.

In the illustrated embodiment of FIG. 3, there are shown two spaced-apart upper link arm tube mounts 284. Though shown as separate mounting structures, in an alternative embodiment, these upper arm mounts 284 may be integrally formed with the tube mounts 276. The upper arm tube mounts 284 include pivots 286 that define pivot axes that are oriented at a canted angle, such as a 45 degree angle shown in FIG. 2B, relative to the axle tube 274. The pivots 286, defined by the pivot axes, may be oriented at any relative angle to the axle tube 274, from parallel to perpendicular. The pivots 286 of the upper arm tube mounts also provide the same degree of freedom of movement for the swivel end 268 as the upper pivot 262a.

Referring again to FIG. 3, an alignment rod 304 connects the axle tube clamp 278 with the upper link arm tube mount 284. The alignment rod 304 extends through a clamp bore 306 in the axle tube clamp 278 and a clamp fastener 308 is threaded into engagement with the alignment rod. The clamp fastener 308 is tightened to secure the axle tube clamp 278 around the axle tube 274. An alignment bore 310 is formed through the upper link arm tube mount 284 to align it with the axle tube clamp 278. This relative alignment aids in properly positioning the upper and lower link arms 266a and 266b for sufficient clearance over their intended range of motion.

The upper shackles 258a, on each side of the wheelchair frame 112, may be interconnected by a suspension sway bar 288. The sway bar 288 connects the upper suspension points to each other and provides an added degree of rigidity to the base frame 112. The axle tube 274 connects the right and left rear wheels together as a solid axle arrangement. Thus, the axle tube 274 provides a rigid and light weight structure to support the rear wheels and provide suspension mounting points inboard of the rear wheels. An anti-tip mounting block 290 may be mounted to the axle tube 274. The anti-tip mounting block 290 may include a bore 292 that is generally perpendicular to the longitudinal axis of the axle tube 274 and may also include an alignment bore 294. The alignment rod 304 may extend the anti-tip block alignment bore 294. The bore 292 may support an anti-tip wheel assembly (not shown). Alternatively, the anti-tip mounting block 290 may be used to rotate and adjust the axle tube and orientation of the plane of the rear wheel camber and toe-in/toe-out adjustment relative to the base frame 112. In other words, the point of the wheels that is closest to the base frame 112 may be rotated towards the front or rear of the wheelchair, effecting a toe adjustment with the camber adjustment.

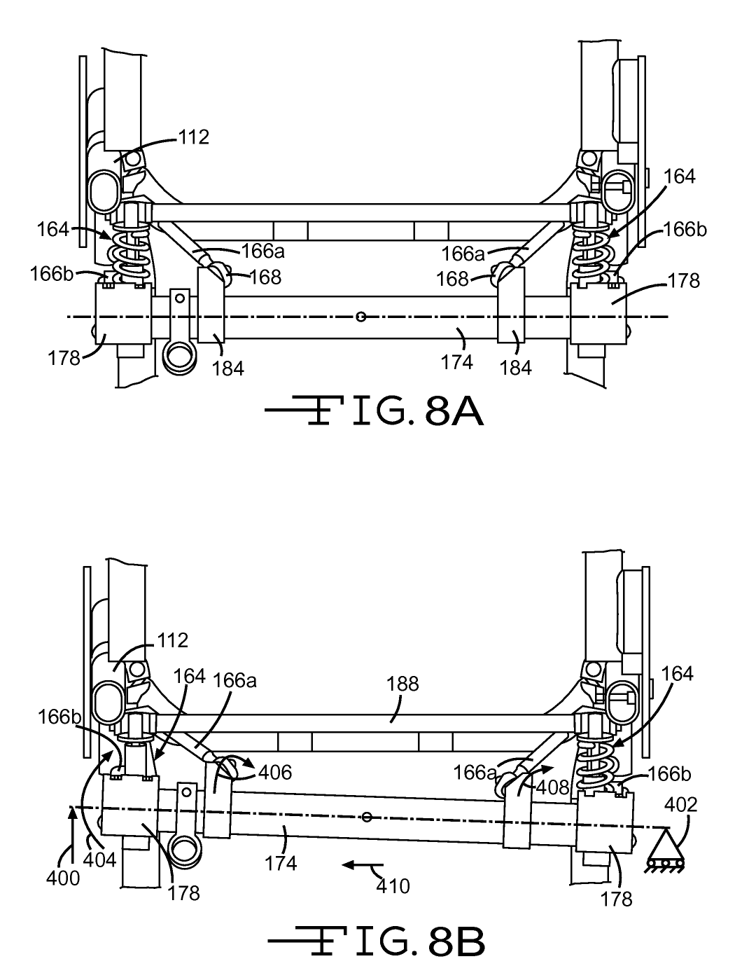

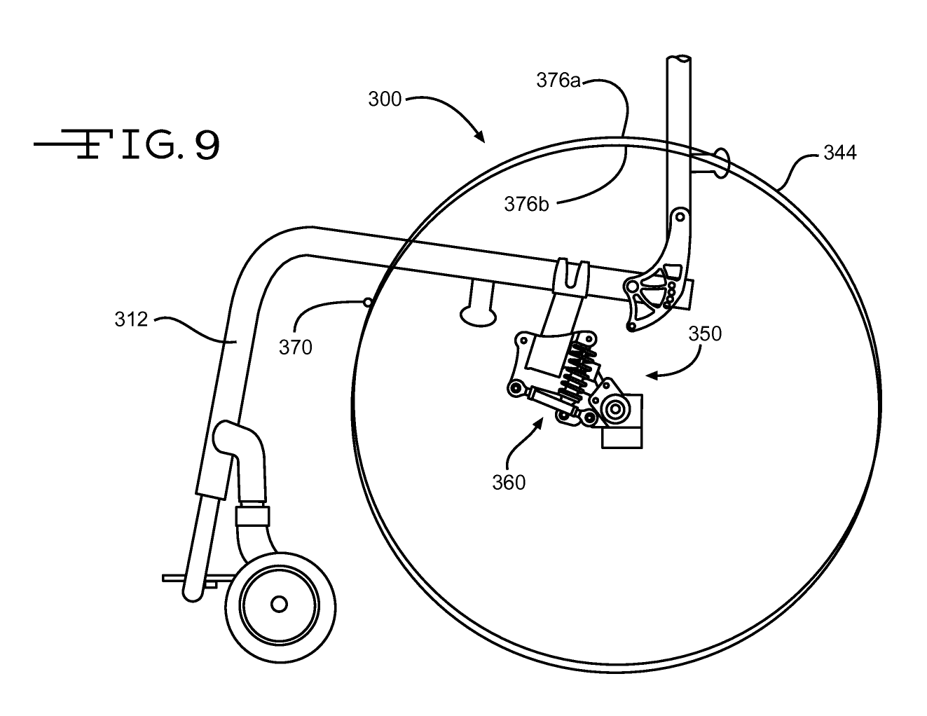

Referring now to FIGS. 8A and 8B, the resiliently mounted axle assembly 150 is illustrated in a neutral or ride height configuration (FIG. 8A) and a deflected condition (FIG. 8B). The deflected condition of FIG. 8B is shown having the left hand wheel (not shown) in a jounce condition where the suspension member 164 is compressed. The right hand wheel (not shown) is not substantially deflected from the neutral position of FIG. 8A, as shown by the rolling-ground symbol 402. When the left hand wheel reacts to a force 400, such as when hitting an obstacle, the left side resilient suspension member 164 compresses. The left side of the axle tube 174 moves up toward the base frame 112. As the suspension 164 compresses, the link arms 166a and 166b are loaded in tension or compression and maintain the axle position relative to the wheelbase length so that the axle does not move toward or away from the rear of the wheelchair 100. The pivot ends 168 of the link arms 166a and 166b swivel and rotate relative to the upper and lower pivots 162a,b; the link arm mount pivot 172; and the upper arm tube mount pivot 186. The amount of movement of the link arms 166a and 166b relative to the various mounting points progressively decreases from the point of deflection at the left wheel to the right wheel in the neutral position, as indicated by the gradually smaller arrows 404, 406, and 408. There may be a slight component of lateral movement of the axle assembly relative to the wheelchair frame 112. However, this component is small and not appreciably felt by a user during suspension excursions.

The kinematic movement of the axle tube 174 may also be characterized as rotation of the axle tube and the deflecting (or most deflected) wheel about the non-moving (not deflected or least deflected) wheel. As shown in FIG. 8B, the non-moving wheel is indicated by the engineering symbol for a grounded point having pivoting and rolling components of movement, shown at 402. The non-moving wheel can pivot relative to the ground in a plane perpendicular to the plane of travel of the wheel (i.e., the forward or rearward rotation of the wheel). As the other wheel deflects and compresses the resilient suspension member 164, the deflecting wheel and axle tube, as rigidly connected elements, rotate about the contact patch of the non-moving wheel on the ground. The degrees of freedom of movement of the 4-bar suspension links 166a and 166b relative to the axle tube 174 permit relative translation of the base frame 112 and the axle tube 174. Thus, the non-moving wheel is also isolated from the deflections of the moving wheel. This isolation is also extended to the base frame 112 and the user. Thus, the user only feels the suspension-isolated reaction of the deflecting wheel, not the shock of both wheels moving or the uneasy feeling of translation of the base frame 112 with the movement of both wheels.

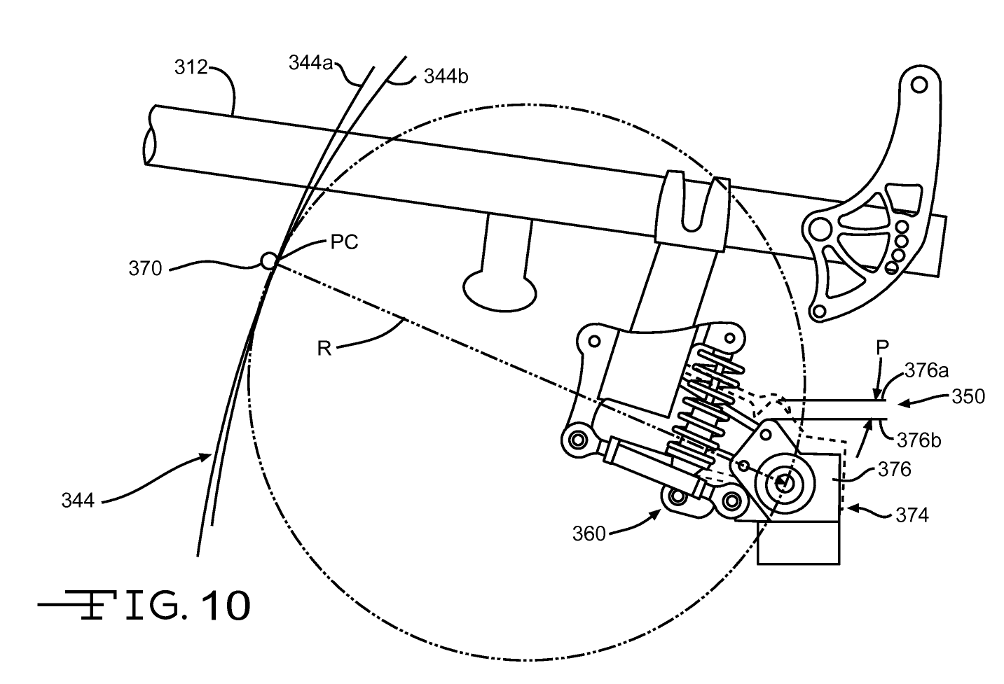

Referring now to FIGS. 9 and 10, there is illustrated another embodiment of a wheelchair frame assembly, shown generally at 300, that includes a resiliently mounted axle assembly, shown generally at 350. The wheelchair frame assembly 300 is similar to the wheelchair frame assembly 100 described above and includes a base frame assembly 312. The base frame assembly 312 supports the resilient axle assembly 350 which also includes a resilient suspension system, shown generally at 360. As shown in FIG. 9, the resilient axle assembly 350 supports rear wheels, shown schematically at 344, for relative rotation and for articulation through a range of motion between a jounce position 344a and a rebound position 344b. The base frame 312 further supports a wheel lock, a schematic representation of which is shown generally at 370. The wheel lock 370 is mounted to the base frame 312, either directly or by way of a mounting bracket, similar to the wheel brake assembly 48, shown in FIG. 1. The wheel lock 370 may be any suitable structure that is capable of either applying a dynamic braking force to a spinning wheel, applying a static wheel locking force to a stopped wheel, or both.

Referring now to FIG. 10, the enlarged view of the resilient suspension system 360 illustrates the pivoting action of an axle tube and assembly 374 relative to the base frame 312 and the wheel lock 370. An axle tube 374 is supported by an axle mount 376 of the resilient suspension system 360 for articulation relative to the base frame 312. An articulation path “P” of the axle tube is generally approximated by an arc length of a circle whose pivot arm “R” emanates from a pivot center “PC” located at or near the contact point of the wheel lock 370 and the wheel 344. Alternatively, the wheel lock 370 or any portion thereof may be the pivot center PC. The length of the pivot arm R is illustrated as being approximately equal to the radius of the wheel 344. However, other pivot arm lengths or other pivot center locations may be used if desired.

As the axle mount 376, of the resilient suspension system 360, articulates between a jounce position 376a and a rebound position 376b, the axle tube 374 travels through an arc which may be approximated by the pivot arm R extending from the wheel lock 370 to the axle tube 374. Thus, the wheel 344 remains in contact with the frame mounted wheel lock 370 as the wheel articulates through the range of suspension motion. Other attempts to provide a wheelchair suspension have required that the wheel lock be supported by the suspension and likewise articulate with the wheel in order to maintain the relative position. These prior attempts often leave the wheel lock in a variety of positions causing the user to search for the release lever. Therefore, mounting the wheel lock 370 to the base frame 312 permits the user to actuate the wheel lock 370 in the same place relative to the base frame 312, regardless of the suspension position of the wheel 344.

Certain features and elements of the various embodiments have been explained with reference to only one embodiment. It should be understood that the various features and elements of the different embodiments described herein may be interchanged or combined with other features and elements of other embodiments.

The principle and mode of operation of this invention have been explained and illustrated in its preferred embodiment. However, it must be understood that this invention may be practiced otherwise than as specifically explained and illustrated without departing from its spirit or scope.

What is claimed is:

1. A wheelchair suspension system comprising:
a base frame;
an axle tube connecting a pair of spaced-apart wheels; and
a four bar linkage configured to permit translation and rotation of the axle tube relative to the base frame.

2. A rear wheel suspension system for a wheelchair comprising:
a suspension mount adapted to support the rear suspension system relative to a wheelchair frame;
an axle tube adapted to support a pair of rear wheels;
a pair of suspension links pivotally supporting each end of the axle tube for vertical movement; and
a resilient member supporting the axle tube, the resilient member being mounted at one end for pivotal movement along a first axis and being mounted at an opposite end for pivotal movement along a second axis that is in a different orientation relative to the first axis.

3. The rear wheel suspension system of claim 2 wherein the first axis is defined by an upper shackle and the second axis is defined by a lower shackle and the first axis is generally perpendicular to the second axis.

4. The rear wheel suspension system of claim 3 wherein the upper shackle is fixed to the suspension mount and the lower shackle is fixed to an axle tube clamp that engages the axle tube.

5. The rear wheel suspension system of claim 3 wherein the upper shackle is fixed to the suspension mount and the lower shackle is pivotally connected to an axle tube clamp that engages the axle tube.

6. The rear wheel suspension system of claim 5 wherein the lower shackle includes a third axis that is generally parallel to the first axis, the resilient member mounted along the first axis of the upper shackle and third axis of the lower shackle, the lower shackle being configured to pivot about the second axis relative to the axle tube clamp.

7. The rear wheel suspension system of claim 2 wherein the suspension mount includes an upper pivot and a lower pivot and the axle tube includes an axle tube clamp having a pivot and a link arm mount having a pivot, the suspension links are configured as upper and lower link arms, the upper link arm pivotally connecting the suspension mount upper pivot and the link arm mount pivot and the lower link arm pivotally connecting the suspension mount lower pivot and the tube clamp pivot.

8. The rear wheel suspension system of claim 7 wherein the suspension mount includes an upper shackle that defines the first pivot axis and a lower shackle defines the second pivot axis, the resilient member being pivotally mounted to the upper and lower shackles.

9. The rear wheel suspension system of claim 8 wherein the first axis is generally perpendicular to the second axis and the upper shackle is fixed to the suspension mount and the lower shackle is fixed to the tube mount.

10. The rear wheel suspension system of claim 8 wherein the first axis is generally perpendicular to the second axis, the upper shackle is fixed to the suspension mount and the lower shackle is pivotally connected to the tube mount along the second axis and includes a third axis that is generally parallel to the first axis, and further the resilient member is pivotally mounted along the first and third axes.

11. A modular rear suspension system configured to resiliently support a wheelchair, the system comprising:
a suspension mount having an upper shackle and a link arm mount, the link arm mount having an upper pivot and a lower pivot;
an axle tube configured to rotatably support a pair of rear wheels;
an axle tube clamp engaging an end of the axle tube, the tube clamp having a pivot and a lower shackle;
a link arm tube mount having a pivot;
an upper link arm supported for pivoting movement between the link arm mount upper pivot and the link arm tube mount pivot;
a lower link arm supported for pivoting movement between the link arm mount lower pivot and the axle tube clamp pivot; and
a resilient member pivotally connected between the upper and lower shackles.

12. The rear wheel suspension system of claim 11 wherein the upper shackle that defines a first pivot axis and the lower shackle defines a second pivot axis that is generally perpendicular to the first pivot axis and the lower shackle is fixed to the tube mount.

13. The rear wheel suspension system of claim 12 wherein the upper shackle defines a first pivot axis and the lower shackle defines a second pivot axis that is generally perpendicular to the first pivot axis, and the lower shackle is pivotally connected to the tube mount along the second axis and includes a third axis that is generally parallel to the first axis, and the resilient member is pivotally mounted along the first and third axes.

14. The rear wheel suspension system of claim 11 wherein the upper and lower link arms connect the upper pivot and the lower pivot to the axle tube, the upper and lower link arms being configured to transfer forward movement of the axle tube to forward movement of the wheelchair and further to permit the axle tube to translate and rotate relative to the base frame.

15. A wheelchair comprising:
a base frame and a wheel lock engaged to a portion of the base frame, the wheel lock being configured for selective engagement with at least one of a pair of wheels;
an axle tube configured to support the pair of wheels for rotation;
a suspension mount configured to support the axle tube for relative movement with the base frame through a range of suspension articulation, the suspension mount connected to a first end of a resilient member and the base frame connected to a second end of the resilient member, and the at least one of the pair of wheels being configured to be selectively engaged by the wheel lock throughout the range of suspension articulation.

16. The wheelchair of claim 15 wherein the suspension mount includes a pair of pivot points and a pair of suspension link arms connect the suspension mount pivot points to the axle tube, the suspension link arms being configured to transfer forward movement of the axle tube to forward movement of the wheelchair and to permit the axle tube to translate and rotate relative to the base frame through the range of suspension articulation.

17. The wheelchair of claim 15 wherein the suspension mount includes an upper shackle and an axle tube clamp engages the axle tube, the axle tube clamp having a lower shackle, and the resilient member is pivotally mounted between the upper shackle and the lower shackle to transfer user weight between the base frame and the axle tube.

18. The wheelchair of claim 17 wherein the upper shackle defines a first pivot axis and the lower shackle defines a second pivot axis that is generally perpendicular to the first pivot axis, the lower shackle being fixed to the tube mount.

19. The wheelchair of claim 17 wherein the upper shackle that defines a first pivot axis and the lower shackle defines a second pivot axis that is generally perpendicular to the first pivot axis and the lower shackle is pivotally connected to the tube mount along the second axis and includes a third axis that is generally parallel to the first axis, and the resilient member is pivotally mounted along the first and third axes.

20. The wheelchair of claim 15 wherein a frame hanger has a frame clamp end that engages the base frame and a sleeve end that cooperates with the suspension mount, the frame clamp being moveable relative to the base frame to adjust the distance between a front caster wheel and the wheel supported on the axle tube, the suspension mount being moveable relative to the sleeve end to adjust the height of the axle tube relative to the base frame.
